(19) United States
(12) Patent Application Publication
(10) Pub. No.: US 2026/0326385 A1
(43) Pub. Date: Oct. 22, 2026

(54) ADDITIVE MANUFACTURING WITH MAGNETIC FLUIDS

(71) Applicant: International Business Machines Corporation, Armonk, NY (US)

(72) Inventors: Hamid MAJDABADI, Ottawa (CA); Humberto OROZCO CERVANTES, Tonalá (MX); Sarbajit Kumar RAKSHIT, Kolkata (IN); Carolina GARCIA DELGADO, Zapopan (MX)

(21) Appl. No.: 19/180,590

(22) Filed: Apr. 16, 2025

(51) Int. Cl. B29C 64/393; B29C 64/209; B33Y 10/00; B33Y 50/02; B33Y 70/00

(52) U.S. Cl. CPC B29C 64/393; B29C 64/209; B33Y 10/00; B33Y 50/02; B33Y 70/00

(57) ABSTRACT

In some implementations, a device may receive an indication of one or more additive manufacturing object geometric parameters and one or more additive manufacturing object variable stiffness parameters. The device may generate, based on the one or more additive manufacturing object geometric parameters and the one or more additive manufacturing object variable stiffness parameters, an additive manufacturing object model that includes a digital representation of one or more magnetic fluid channels. The device may transmit, based on the one or more additive manufacturing object geometric parameters and the one or more additive manufacturing object variable stiffness parameters, one or more first commands to prepare one or more magnetic fluids. The device may transmit one or more second commands to construct an additive manufacturing object that includes the one or more magnetic fluids in the one or more magnetic fluid channels.

### BACKGROUND

This disclosure relates to additive manufacturing, and more specifically, to additive manufacturing with magnetic fluids.

### SUMMARY

Some aspects described herein relate to a computer-implemented method. The computer-implemented method may include receiving, by a device, an indication of one or more additive manufacturing object geometric parameters and one or more additive manufacturing object variable stiffness parameters. The computer-implemented method may include generating, by the device, based on the one or more additive manufacturing object geometric parameters and the one or more additive manufacturing object variable stiffness parameters, an additive manufacturing object model that includes a digital representation of one or more magnetic fluid channels. The computer-implemented method may include transmitting, by the device, based on the one or more additive manufacturing object geometric parameters and the one or more additive manufacturing object variable stiffness parameters, one or more first commands to prepare one or more magnetic fluids. The computer-implemented method may include transmitting, by the device, one or more second commands to construct an additive manufacturing object that includes the one or more magnetic fluids in the one or more magnetic fluid channels.

Some aspects described herein relate to a computer system. The computer system may include a processor set, one or more computer-readable storage media, and program instructions stored on the one or more computer-readable storage media to cause the processor set to perform operations. The operations may include receiving an indication of one or more additive manufacturing object geometric parameters and one or more additive manufacturing object variable stiffness parameters. The operations may include generating, based on the one or more additive manufacturing object geometric parameters and the one or more additive manufacturing object variable stiffness parameters, an additive manufacturing object model that includes a digital representation of one or more magnetic fluid channels. The operations may include transmitting, based on the one or more additive manufacturing object geometric parameters and the one or more additive manufacturing object variable stiffness parameters, one or more first commands to prepare one or more magnetic fluids. The operations may include transmitting one or more second commands to construct an additive manufacturing object that includes the one or more magnetic fluids in the one or more magnetic fluid channels using one or more first nozzles associated with the one or more magnetic fluids and one or more second nozzles associated with one or more additive manufacturing materials that are different from the one or more magnetic fluids.

Some aspects described herein relate to a computer program product. The computer program product may include one or more computer-readable storage media and program instructions stored on the one or more computer-readable storage media to perform operations. The operations may include receiving an indication of one or more additive manufacturing object geometric parameters and one or more additive manufacturing object variable stiffness parameters. The operations may include generating, based on the one or more additive manufacturing object geometric parameters and the one or more additive manufacturing object variable stiffness parameters, an additive manufacturing object model that includes a digital representation of one or more magnetic fluid channels and one or more magnetic field source components associated with one or more electromagnetic coils. The operations may include transmitting, based on the one or more additive manufacturing object geometric parameters and the one or more additive manufacturing object variable stiffness parameters, one or more first commands to prepare one or more magnetic fluids. The operations may include transmitting one or more second commands to construct an additive manufacturing object that includes the one or more magnetic fluids in the one or more magnetic fluid channels.

### BRIEF DESCRIPTION OF THE DRAWINGS

FIG. 1 is a diagram of an example computing environment for additive manufacturing with magnetic fluids as described herein.

FIGS. 2A-2B are diagrams of an example associated with additive manufacturing with magnetic fluids as described herein.

FIG. 3 is a diagram of example components of a device associated with additive manufacturing with magnetic fluids.

FIG. 4 is a flowchart of an example process associated with additive manufacturing with magnetic fluids.

### DETAILED DESCRIPTION

The following detailed description of example implementations refers to the accompanying drawings. The same reference numbers in different drawings may identify the same or similar elements.

The following provides an overview of some implementations of the present disclosure:

In some implementations, a computer-implemented method includes receiving, by a device, an indication of one or more additive manufacturing object geometric parameters and one or more additive manufacturing object variable stiffness parameters. In some implementations, the computer-implemented method includes generating, by the device, based on the one or more additive manufacturing object geometric parameters and the one or more additive manufacturing object variable stiffness parameters, an additive manufacturing object model that includes a digital representation of one or more magnetic fluid channels. In some implementations, the computer-implemented method includes transmitting, by the device, based on the one or more additive manufacturing object geometric parameters and the one or more additive manufacturing object variable stiffness parameters, one or more first commands to prepare one or more magnetic fluids. In some implementations, the computer-implemented method includes transmitting, by the device, one or more second commands to construct an additive manufacturing object that includes the one or more magnetic fluids in the one or more magnetic fluid channels. The resulting additive manufacturing object may be programmatically controlled using a magnetic field that is applied in the vicinity of the magnetic fluid. For example, adjusting the strength of the magnetic field may lead to a change in stiffness of the magnetic fluid(s), and, thus, in the magnetic fluid channel(s) of the additive manufacturing object. For example, increasing the magnetic field strength may decrease the mobility of the magnetic fluid and increase the stiffness, and decreasing the magnetic field strength may increase the mobility of the magnetic fluid and decrease the stiffness. As a result, by subjecting the additive manufacturing object to one or more external, programmatically-varying magnetic field strengths, one or more target stiffnesses of the additive manufacturing object may be achieved and/or precisely fine-tuned. The target stiffnesses may be adapted depending on a particular task to be performed by the additive manufacturing object, or on one or more conditions (e.g., environmental conditions) that are present while the particular task is to be performed. Thus, the additive manufacturing object may have an enhanced functionality or performance such that the additive manufacturing object may be suitable for multiple tasks and/or under multiple conditions. This suitability for multiple tasks and/or conditions may help to reduce a demand for multiple additive manufacturing objects that would otherwise be produced for use in individual tasks and/or conditions. As a result, an additive manufacturing system (e.g., a 3D printer) may produce a single additive manufacturing object with adaptable stiffness that is capable of performing various tasks under various conditions, instead of producing multiple additive manufacturing objects that are capable of performing only limited tasks under limited conditions. Thus, the additive manufacturing object may help to conserve processing, memory, and/or network resources of the additive manufacturing system that would otherwise be occupied with producing multiple additive manufacturing objects. Additionally, or alternatively, the additive manufacturing object may help to conserve processing, memory, and/or network resources of the additive manufacturing system because the additive manufacturing object may have mechanical components with reduced complexity and/or lower self-weight.

In some implementations, the one or more second commands are to construct the additive manufacturing object using one or more first nozzles associated with the one or more magnetic fluids and one or more second nozzles associated with one or more additive manufacturing materials that are different from the one or more magnetic fluids. Using first nozzle(s) associated with magnetic fluid(s) and second nozzle(s) associated with additive manufacturing material(s) may help to reduce complexity and/or production time for an additive manufacturing process, thereby further conserving processing, memory, and/or network resources. Additionally, or alternatively, printing quality may increase (e.g., due to proper management of magnetic fluids using the first command(s) and/or the second command(s)), thereby reducing repeated additive manufacturing processes for a given additive manufacturing object, and, thus, further conserving processing, memory, and/or network resources.

In some implementations, the one or more first commands or the one or more second commands are based on one or more idle times of the one or more first nozzles or the one or more second nozzles. Basing the one or more first commands or the one or more second commands on the idle time(s) may help to increase productivity of the additive manufacturing system by further reducing a production time for an additive manufacturing process, thereby further conserving processing, memory, and/or network resources.

In some implementations, the additive manufacturing object model includes a digital representation of one or more magnetic field source components. As a result, the one or more magnetic field source components may be integrated with the additive manufacturing object, thereby increasing granularity of magnetic field strength applied to the additive manufacturing object as compared to a scenario in which a magnetic field source is physically separate from the additive manufacturing object. Thus, the resulting additive manufacturing object may help to further conserve processing, memory, and/or network resources of the additive manufacturing system that would otherwise be occupied with producing multiple additive manufacturing objects.

In some implementations, the one or more magnetic field source components are associated with one or more electromagnetic coils. The magnetic field source components being associated with the electromagnetic coil(s) may help to reduce a complexity associated with a design and/or manufacture of the additive manufacturing object. Therefore, the electromagnetic coil(s) may help to further conserve processing, memory, and/or network resources of the additive manufacturing system.

In some implementations, the one or more magnetic fluids include multiple magnetic fluids, and the one or more magnetic fluid channels include multiple magnetic fluid channels that include respective magnetic fluids of the multiple magnetic fluids. The multiple magnetic fluids and multiple magnetic fluid channels may help to increase a granularity of control over the programmatically-controlled stiffness ranges of various portions of the additive manufacturing object, thereby further increasing a quantity of tasks or conditions suitable for the additive manufacturing object and, thus, further conserving processing, memory, and/or network resources of the additive manufacturing system.

In some implementations, generating the additive manufacturing object model includes generating the additive manufacturing object model based on one or more simulations of the additive manufacturing object in accordance with the one or more additive manufacturing object geometric parameters and the one or more additive manufacturing object variable stiffness parameters. The simulation(s) may help to further conserve processing, memory, and/or network resources of the additive manufacturing system by reducing a quantity of additive manufacturing objects to be produced by the additive manufacturing system. For example, the simulation(s) may improve an accuracy or a performance of the additive manufacturing object model, thereby reducing demand for 3D-printed iterations of the additive manufacturing object with progressively improved accuracy or performance. Additionally, or alternatively, the simulation(s) may enable the additive manufacturing system to predict the accuracy or performance of the additive manufacturing object without printing one or more prototypes.

In some implementations, the one or more first commands are based on one or more of one or more target compositions of the one or more magnetic fluids or one or more target viscosities of the one or more magnetic fluids. Basing the first commands on the target compositions or target viscosities of the magnetic fluids may help to improve a performance of the magnetic fluids while the additive manufacturing object is in use (e.g., under an applied magnetic field), thereby further conserving processing, memory, and/or network resources of the additive manufacturing system.

In some implementations, a computer system includes a processor set, one or more computer-readable storage media, and program instructions stored on the one or more computer-readable storage media to cause the processor set to perform operations. In some implementations, the operations include receiving an indication of one or more additive manufacturing object geometric parameters and one or more additive manufacturing object variable stiffness parameters. In some implementations, the operations include generating, based on the one or more additive manufacturing object geometric parameters and the one or more additive manufacturing object variable stiffness parameters, an additive manufacturing object model that includes a digital representation of one or more magnetic fluid channels. In some implementations, the operations include transmitting, based on the one or more additive manufacturing object geometric parameters and the one or more additive manufacturing object variable stiffness parameters, one or more first commands to prepare one or more magnetic fluids. In some implementations, the operations include transmitting one or more second commands to construct an additive manufacturing object that includes the one or more magnetic fluids in the one or more magnetic fluid channels using one or more first nozzles associated with the one or more magnetic fluids and one or more second nozzles associated with one or more additive manufacturing materials that are different from the one or more magnetic fluids. The resulting additive manufacturing object may be programmatically controlled using a magnetic field that is applied in the vicinity of the magnetic fluid. For example, adjusting the strength of the magnetic field may lead to a change in stiffness of the magnetic fluid(s), and, thus, in the magnetic fluid channel(s) of the additive manufacturing object. For example, increasing the magnetic field strength may decrease the mobility of the magnetic fluid and increase the stiffness, and decreasing the magnetic field strength may increase the mobility of the magnetic fluid and decrease the stiffness. As a result, by subjecting the additive manufacturing object to one or more external, programmatically-varying magnetic field strengths, one or more target stiffnesses of the additive manufacturing object may be achieved and/or precisely fine-tuned. The target stiffnesses may be adapted depending on a particular task to be performed by the additive manufacturing object, or on one or more conditions (e.g., environmental conditions) that are present while the particular task is to be performed. Thus, the additive manufacturing object may have an enhanced functionality or performance such that the additive manufacturing object may be suitable for multiple tasks and/or under multiple conditions. This suitability for multiple tasks and/or conditions may help to reduce a demand for multiple additive manufacturing objects that would otherwise be produced for use in individual tasks and/or conditions. As a result, the additive manufacturing system may produce a single additive manufacturing object with adaptable stiffness that is capable of performing various tasks under various conditions, instead of producing multiple additive manufacturing objects that are capable of performing only limited tasks under limited conditions. Thus, the additive manufacturing object may help to conserve processing, memory, and/or network resources of the additive manufacturing system that would otherwise be occupied with producing multiple additive manufacturing objects. Additionally, or alternatively, the additive manufacturing object may help to conserve processing, memory, and/or network resources of the additive manufacturing system because the additive manufacturing object may have mechanical components with reduced complexity and/or lower self-weight. Moreover, using first nozzle(s) associated with magnetic fluid(s) and second nozzle(s) associated with additive manufacturing material(s) may help to reduce complexity and/or production time for an additive manufacturing process, thereby further conserving processing, memory, and/or network resources. Additionally, or alternatively, printing quality may increase (e.g., due to proper management of magnetic fluids using the first command(s) and/or the second command(s)), thereby reducing repeated additive manufacturing processes for a given additive manufacturing object, and, thus, further conserving processing, memory, and/or network resources.

In some implementations, the one or more first commands or the one or more second commands are based on one or more idle times of the one or more first nozzles or the one or more second nozzles. Basing the one or more first commands or the one or more second commands on the idle time(s) may help to increase productivity of the additive manufacturing system by further reducing a production time for an additive manufacturing process, thereby further conserving processing, memory, and/or network resources.

In some implementations, the additive manufacturing object model includes a digital representation of one or more magnetic field source components. As a result, the one or more magnetic field source components may be integrated with the additive manufacturing object, thereby increasing granularity of magnetic field strength applied to the additive manufacturing object as compared to a scenario in which a magnetic field source is physically separate from the additive manufacturing object. Thus, the resulting additive manufacturing object may help to further conserve processing, memory, and/or network resources of the additive manufacturing system that would otherwise be occupied with producing multiple additive manufacturing objects.

In some implementations, the one or more magnetic fluids include multiple magnetic fluids, and the one or more magnetic fluid channels include multiple magnetic fluid channels that include respective magnetic fluids of the multiple magnetic fluids. The multiple magnetic fluids and multiple magnetic fluid channels may help to increase a granularity of control over the programmatically-controlled stiffness ranges of various portions of the additive manufacturing object, thereby further increasing a quantity of tasks or conditions suitable for the additive manufacturing object and, thus, further conserving processing, memory, and/or network resources of the additive manufacturing system.

In some implementations, generating the additive manufacturing object model includes generating the additive manufacturing object model based on one or more simulations of the additive manufacturing object in accordance with the one or more additive manufacturing object geometric parameters and the one or more additive manufacturing object variable stiffness parameters. The simulation(s) may help to further conserve processing, memory, and/or network resources of the additive manufacturing system by reducing a quantity of additive manufacturing objects to be produced by the additive manufacturing system. For example, the simulation(s) may improve an accuracy or a performance of the additive manufacturing object model, thereby reducing demand for 3D-printed iterations of the additive manufacturing object with progressively improved accuracy or performance. Additionally, or alternatively, the simulation(s) may enable the additive manufacturing system to predict the accuracy or performance of the additive manufacturing object without printing one or more prototypes.

In some implementations, the one or more first commands are based on one or more of one or more target compositions of the one or more magnetic fluids or one or more target viscosities of the one or more magnetic fluids. Basing the first commands on the target compositions or target viscosities of the magnetic fluids may help to improve a performance of the magnetic fluids while the additive manufacturing object is in use (e.g., under an applied magnetic field), thereby further conserving processing, memory, and/or network resources of the additive manufacturing system.

In some implementations, a computer program product includes one or more computer-readable storage media and program instructions stored on the one or more computer-readable storage media to perform operations. In some implementations, the operations include receiving an indication of one or more additive manufacturing object geometric parameters and one or more additive manufacturing object variable stiffness parameters. In some implementations, the operations include generating, based on the one or more additive manufacturing object geometric parameters and the one or more additive manufacturing object variable stiffness parameters, an additive manufacturing object model that includes a digital representation of one or more magnetic fluid channels and one or more magnetic field source components associated with one or more electromagnetic coils. In some implementations, the operations include transmitting, based on the one or more additive manufacturing object geometric parameters and the one or more additive manufacturing object variable stiffness parameters, one or more first commands to prepare one or more magnetic fluids. In some implementations, the operations include transmitting one or more second commands to construct an additive manufacturing object that includes the one or more magnetic fluids in the one or more magnetic fluid channels. The resulting additive manufacturing object may be programmatically controlled using a magnetic field that is applied in the vicinity of the magnetic fluid. For example, adjusting the strength of the magnetic field may lead to a change in stiffness of the magnetic fluid(s), and, thus, in the magnetic fluid channel(s) of the additive manufacturing object. For example, increasing the magnetic field strength may decrease the mobility of the magnetic fluid and increase the stiffness, and decreasing the magnetic field strength may increase the mobility of the magnetic fluid and decrease the stiffness. As a result, by subjecting the additive manufacturing object to one or more external, programmatically-varying magnetic field strengths, one or more target stiffnesses of the additive manufacturing object may be achieved and/or precisely fine-tuned. The target stiffnesses may be adapted depending on a particular task to be performed by the additive manufacturing object, or on one or more conditions (e.g., environmental conditions) that are present while the particular task is to be performed. Thus, the additive manufacturing object may have an enhanced functionality or performance such that the additive manufacturing object may be suitable for multiple tasks and/or under multiple conditions. This suitability for multiple tasks and/or conditions may help to reduce a demand for multiple additive manufacturing objects that would otherwise be produced for use in individual tasks and/or conditions. As a result, the additive manufacturing system may produce a single additive manufacturing object with adaptable stiffness that is capable of performing various tasks under various conditions, instead of producing multiple additive manufacturing objects that are capable of performing only limited tasks under limited conditions. Thus, the additive manufacturing object may help to conserve processing, memory, and/or network resources of the additive manufacturing system that would otherwise be occupied with producing multiple additive manufacturing objects. Additionally, or alternatively, the additive manufacturing object may help to conserve processing, memory, and/or network resources of the additive manufacturing system because the additive manufacturing object may have mechanical components with reduced complexity and/or lower self-weight. Moreover, the one or more magnetic field source components may be integrated with the additive manufacturing object, thereby increasing granularity of magnetic field strength applied to the additive manufacturing object as compared to a scenario in which a magnetic field source is physically separate from the additive manufacturing object. Thus, the resulting additive manufacturing object may help to further conserve processing, memory, and/or network resources of the additive manufacturing system that would otherwise be occupied with producing multiple additive manufacturing objects. Furthermore, the magnetic field source components being associated with the electromagnetic coil(s) may help to reduce a complexity associated with a design and/or manufacture of the additive manufacturing object. Therefore, the electromagnetic coil(s) may help to further conserve processing, memory, and/or network resources of the additive manufacturing system.

In some implementations, the one or more second commands are to construct the additive manufacturing object using one or more first nozzles associated with the one or more magnetic fluids and one or more second nozzles associated with one or more additive manufacturing materials that are different from the one or more magnetic fluids. Using first nozzle(s) associated with magnetic fluid(s) and second nozzle(s) associated with additive manufacturing material(s) may help to reduce complexity and/or production time for an additive manufacturing process, thereby further conserving processing, memory, and/or network resources. Additionally, or alternatively, printing quality may increase (e.g., due to proper management of magnetic fluids using the first command(s) and/or the second command(s)), thereby reducing repeated additive manufacturing processes for a given additive manufacturing object, and, thus, further conserving processing, memory, and/or network resources.

In some implementations, the one or more first commands or the one or more second commands are based on one or more idle times of the one or more first nozzles or the one or more second nozzles. Basing the one or more first commands or the one or more second commands on the idle time(s) may help to increase productivity of the additive manufacturing system by further reducing a production time for an additive manufacturing process, thereby further conserving processing, memory, and/or network resources.

In some implementations, the one or more magnetic fluids include multiple magnetic fluids, and the one or more magnetic fluid channels include multiple magnetic fluid channels that include respective magnetic fluids of the multiple magnetic fluids. The multiple magnetic fluids and multiple magnetic fluid channels may help to increase a granularity of control over the programmatically-controlled stiffness ranges of various portions of the additive manufacturing object, thereby further increasing a quantity of tasks or conditions suitable for the additive manufacturing object and, thus, further conserving processing, memory, and/or network resources of the additive manufacturing system.

In some implementations, generating the additive manufacturing object model includes generating the additive manufacturing object model based on one or more simulations of the additive manufacturing object in accordance with the one or more additive manufacturing object geometric parameters and the one or more additive manufacturing object variable stiffness parameters. The simulation(s) may help to further conserve processing, memory, and/or network resources of the additive manufacturing system by reducing a quantity of additive manufacturing objects to be produced by the additive manufacturing system. For example, the simulation(s) may improve an accuracy or a performance of the additive manufacturing object model, thereby reducing demand for 3D-printed iterations of the additive manufacturing object with progressively improved accuracy or performance. Additionally, or alternatively, the simulation(s) may enable the additive manufacturing system to predict the accuracy or performance of the additive manufacturing object without printing one or more prototypes.

In some implementations, the one or more first commands are based on one or more of one or more target compositions of the one or more magnetic fluids or one or more target viscosities of the one or more magnetic fluids. Basing the first commands on the target compositions or target viscosities of the magnetic fluids may help to improve a performance of the magnetic fluids while the additive manufacturing object is in use (e.g., under an applied magnetic field), thereby further conserving processing, memory, and/or network resources of the additive manufacturing system.

A magnetic fluid is a type of fluid that exhibits a change in behavior or properties in the presence of a magnetic field. Magnetic fluids may include a suspension of magnetic particles dispersed in a carrier fluid. Magnetic fluids can be categorized into various types having different applications. For example, magnetic fluids may be ferrofluids, magnetorheological (MR) fluids, or electrorheological (ER) fluids.

Ferrofluids are liquids that are attracted to the poles of a magnet, such as colloidal liquids that include magnetic particles (e.g., nanoscale ferromagnetic or ferrimagnetic particles) suspended in a carrier fluid (e.g., an organic solvent or water). Ferrofluids may be highly responsive to magnetic fields. For example, ferrofluids may exhibit changes in flow and viscosity in the presence of a magnetic field. For example, ferrofluids may stiffen, flow differently, or align along magnetic field lines. The particles in a ferrofluid are suspended by Brownian motion and do not typically settle under normal conditions. Each magnetic particle may be coated with a surfactant, which may inhibit clumping and thereby allow ferrofluids to remain homogeneous colloidal mixtures. When exposed to strong magnetic fields, large ferromagnetic particles may be ripped out of the mixture, forming a separate clump of magnetic dust; the magnetic attraction of tiny nanoparticles is weak enough that a Van der Waals force of the surfactant is sufficient to prevent magnetic clumping or agglomeration. Generally, ferrofluids do not retain magnetization in the absence of an external magnetic field and, thus, are often classified as superparamagnets rather than ferromagnets.

Magnetorheological (MR) fluids include micron-scale magnetic particles that change viscosity in the presence of a magnetic field. For example, when the magnetic field is applied, the particles form chains, which causes the fluid to approximate a solid and become resistant to flow. When the magnetic field is removed, the MR fluid may return to a liquid state. Because particles in an MR fluid are too heavy to be suspended by Brownian motion, MR fluids are susceptible to settling over time due to the inherent density difference between the particles and the carrier fluid.

Electrorheological (ER) fluids behave in electric fields in a manner similar to the behavior of MR fluids in magnetic fields. Under an electric field, the particles in ER fluids align, which may lead to a change in viscosity.

In the presence of a magnetic or electric field, properties of a magnetic fluid can change. For example, a magnetic fluid can, under a magnetic or electric field, become stiffer. Stiffness is a measure of resistance of an elastic body to extension, deflection, or deformation by an applied force (such as a force applied by a magnetic or electric field). For example, a stiffness k may be expressed as F / δ, where F is the applied force and δ is the extension, deflection, or deformation (as measured in units of distance).

Additive manufacturing, such as three-dimensional (3D) printing, can rapidly create complex objects with various applications and properties. For example, 3D-printed objects may include robotic grippers, soft robotics, exoskeletons, shock absorption systems, other robotics components, prosthetics, dynamic tools, or the like. However, traditional 3D printing techniques often struggle to produce objects with adaptable stiffness for performing different activities. As a result, 3D-printed objects may lack customizable, real-time stiffness modulation, which can hamper the functionality of such objects in carrying out different tasks or responding to changing conditions that require the object to have different stiffnesses. For example, a 3D-printed object that has a static stiffness may be suitable for only a single task, or a subset of tasks. For example, a robotic gripper with a given static stiffness may be limited to gripping only certain objects (e.g., because the static stiffness of the robotic gripper may prevent the robotic gripper from gripping certain classes of objects effectively, and/or cause the robotic gripper to damage certain classes of objects). As a result, 3D printers may allocate memory, processing, and/or network resources for producing multiple objects, and/or an object having complex mechanical parts and/or large self-weights, capable of handling respective tasks or conditions. For example, 3D printers may process multiple object models and manufacture the multiple objects based on those object models, which may increase computational overhead and resource consumption relative to producing fewer 3D-printed objects.

Some implementations described herein enable a 3D printer to print objects with programmatically controlled stiffness in different portions of the object. For example, the 3D printer may receive a 3D model of an object, and an indication of one or more target stiffness ranges for one or more portions of the object. The 3D printer may modify the 3D model based on the target stiffness ranges such that the 3D model includes a digital representation of one or more magnetic fluid channels in the one or more portions. A mixing chamber may prepare one or more magnetic fluids that are to fill the one or more magnetic fluid channels. The magnetic fluid(s) may be prepared with appropriate composition(s) that will enable the one or more portions of the object to adopt programmatic stiffness values within the target stiffness range(s). The 3D printer may construct the object, including injecting the magnetic fluid(s) in the magnetic fluid channel(s).

As a result, the 3D-printed object may be programmatically controlled using a magnetic field that is applied in the vicinity of the magnetic fluid. For example, adjusting the strength of the magnetic field may lead to a change in stiffness of the magnetic fluid(s), and, thus, in the magnetic fluid channel(s) of the 3D-printed object. For example, increasing the magnetic field strength may decrease the mobility of the magnetic fluid and increase the stiffness, and decreasing the magnetic field strength may increase the mobility of the magnetic fluid and decrease the stiffness. As a result, by subjecting the 3D-printed object to one or more external, programmatically-varying magnetic field strengths, one or more target stiffnesses of the 3D-printed object may be achieved and/or precisely fine-tuned. The target stiffnesses may be adapted depending on a particular task to be performed by the 3D-printed object, or on one or more conditions (e.g., environmental conditions) that are present while the particular task is to be performed. Thus, the 3D-printed object may have an enhanced functionality or performance such that the 3D-printed object may be suitable for multiple tasks and/or under multiple conditions. This suitability for multiple tasks and/or conditions may help to reduce a demand for multiple 3D-printed objects that would otherwise be produced for use in individual tasks and/or conditions. As a result, the 3D printer may produce a single object with adaptable stiffness that is capable of performing various tasks under various conditions, instead of producing multiple objects that are capable of performing only limited tasks under limited conditions. Thus, the 3D-printed object may help to conserve processing, memory, and/or network resources of the 3D printer that would otherwise be occupied with producing multiple 3D-printed objects. Additionally, or alternatively, the 3D-printed object may help to conserve processing, memory, and/or network resources of the additive manufacturing system because the 3D-printed object may have mechanical components with reduced complexity and/or lower self-weight.

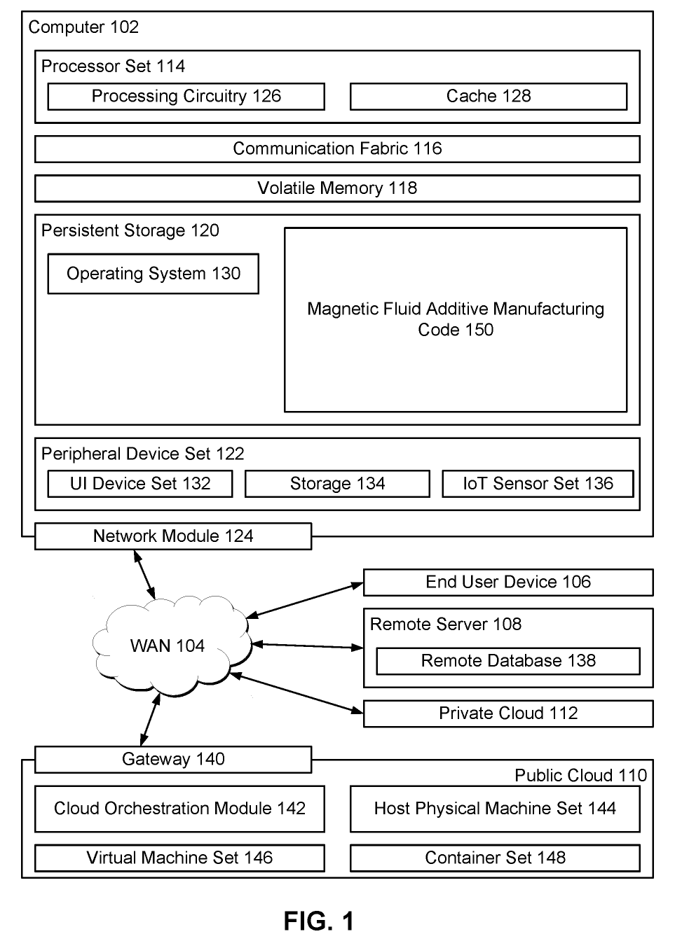

FIG. 1 is a diagram of an example computing environment 100 for additive manufacturing with magnetic fluids as described herein.

The computing environment 100 contains an example of an environment for the execution of at least some of the computer code involved in performing the inventive methods, such as magnetic fluid additive manufacturing code 150. In addition to the magnetic fluid additive manufacturing code 150, the computing environment 100 includes, for example, a computer 102, a wide area network (WAN) 104, an end user device (EUD) 106, a remote server 108, a public cloud 110, and a private cloud 112. In this embodiment, the computer 102 includes a processor set 114 (including processing circuitry 126 and a cache 128), communication fabric 116, volatile memory 118, persistent storage 120 (including an operating system 130 and the magnetic fluid additive manufacturing code 150, as identified above), a peripheral device set 122 (including a user interface (UI) device set 132, storage 134, and an Internet of Things (IoT) sensor set 136), and a network module 124. The remote server 108 includes a remote database 138. The public cloud 110 includes a gateway 140, a cloud orchestration module 142, a host physical machine set 144, a virtual machine set 146, and a container set 148.

The computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 138. As is well understood in the art of computer technology, and depending upon the technology, performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, the computer 102 is not required to be in a cloud except to any extent as may be affirmatively indicated.

Computer-readable program instructions are typically loaded onto the computer 102 to cause a series of operational steps to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 128 and the other storage media discussed below. The program instructions, and associated data, are accessed by the processor set 114 to control and direct performance of the inventive methods. In the computing environment 100, at least some of the instructions for performing the inventive methods may be stored in magnetic fluid additive manufacturing code 150 in the persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, and/or physical input / output ports, among other examples. Other types of signal communication paths may be used, such as fiber optic communication paths and/or wireless communication paths, among other examples.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to the computer 102, but, alternatively or additionally, the volatile memory 118 may be distributed over multiple packages and/or located externally with respect to the computer 102.

The code included in the magnetic fluid additive manufacturing code 150 typically includes at least some of the computer code involved in performing one or more operations described herein. In some implementations, the operations may include receiving an indication of one or more additive manufacturing object geometric parameters and one or more additive manufacturing object variable stiffness parameters; generating, based on the one or more additive manufacturing object geometric parameters and the one or more additive manufacturing object variable stiffness parameters, an additive manufacturing object model that includes a digital representation of one or more magnetic fluid channels; transmitting, based on the one or more additive manufacturing object geometric parameters and the one or more additive manufacturing object variable stiffness parameters, one or more first commands to prepare one or more magnetic fluids; and transmitting one or more second commands to construct an additive manufacturing object that includes the one or more magnetic fluids in the one or more magnetic fluid channels.

In some implementations, the operations may include receiving an indication of one or more additive manufacturing object geometric parameters and one or more additive manufacturing object variable stiffness parameters; generating, based on the one or more additive manufacturing object geometric parameters and the one or more additive manufacturing object variable stiffness parameters, an additive manufacturing object model that includes a digital representation of one or more magnetic fluid channels; transmitting, based on the one or more additive manufacturing object geometric parameters and the one or more additive manufacturing object variable stiffness parameters, one or more first commands to prepare one or more magnetic fluids; and transmitting one or more second commands to construct an additive manufacturing object that includes the one or more magnetic fluids in the one or more magnetic fluid channels using one or more first nozzles associated with the one or more magnetic fluids and one or more second nozzles associated with one or more additive manufacturing materials that are different from the one or more magnetic fluids.

In some implementations, the operations may include receiving an indication of one or more additive manufacturing object geometric parameters and one or more additive manufacturing object variable stiffness parameters; generating, based on the one or more additive manufacturing object geometric parameters and the one or more additive manufacturing object variable stiffness parameters, an additive manufacturing object model that includes a digital representation of one or more magnetic fluid channels and one or more magnetic field source components associated with one or more electromagnetic coils; transmitting, based on the one or more additive manufacturing object geometric parameters and the one or more additive manufacturing object variable stiffness parameters, one or more first commands to prepare one or more magnetic fluids; and transmitting one or more second commands to construct an additive manufacturing object that includes the one or more magnetic fluids in the one or more magnetic fluid channels.

The peripheral device set 122 includes the set of peripheral devices of the computer 102. Data communication connections between the peripheral devices and the other components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 132 may include components such as a display screen, speaker, microphone, wearable devices (such as goggles and smart watches), keyboard, mouse, printer, touchpad, game controllers, and haptic devices. The storage 134 is external storage, such as an external hard drive, or insertable storage, such as an SD card. The storage 134 may be persistent and/or volatile. In some embodiments, the storage 134 may take the form of a quantum computing storage device for storing data in the form of qubits. In embodiments where the computer 102 is required to have a large amount of storage (for example, where the computer 102 locally stores and manages a large database), then this storage may be provided by peripheral storage devices designed for storing very large amounts of data, such as a storage area network (SAN) that is shared by multiple, geographically distributed computers. The IoT sensor set 136 is made up of sensors that can be used in Internet of Things applications. For example, one sensor may be a thermometer and another sensor may be a motion detector.

The network module 124 is the collection of computer software, hardware, and firmware that allows the computer 102 to communicate with other computers through the WAN 104. The network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 124 are performed on the same physical hardware device. In other embodiments (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods can typically be downloaded to the computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and/or edge servers, among other examples.

The EUD 106 is any computer system that is used and controlled by an end user (for example, a customer of an enterprise that operates the computer 102), and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or otherwise present, the recommendation to an end user. In some embodiments, the EUD 106 may be a client device, such as thin client, heavy client, mainframe computer, and/or desktop computer, among other examples.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 138 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 110 is performed by the computer hardware and/or software of the cloud orchestration module 142. The computing resources provided by the public cloud 110 are typically implemented by virtual computing environments that run on various computers making up the computers of the host physical machine set 144, which is the universe of physical computers in and/or available to the public cloud 110. The virtual computing environments (VCEs) typically take the form of virtual machines from the virtual machine set 146 and/or containers from the container set 148. It is understood that these VCEs may be stored as images and may be transferred among and between the various physical machine hosts, either as images or after instantiation of the VCE. The cloud orchestration module 142 manages the transfer and storage of images, deploys new instantiations of VCEs and manages active instantiations of VCE deployments. The gateway 140 is the collection of computer software, hardware, and firmware that allows the public cloud 110 to communicate through the WAN 104.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 110 and the private cloud 112 are both part of a larger hybrid cloud.

Cloud computing services and/or microservices (not separately shown in FIG. 1): private cloud 112 and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

FIG. 1 is provided as an example. Other examples may differ from what is described with regard to FIG. 1.

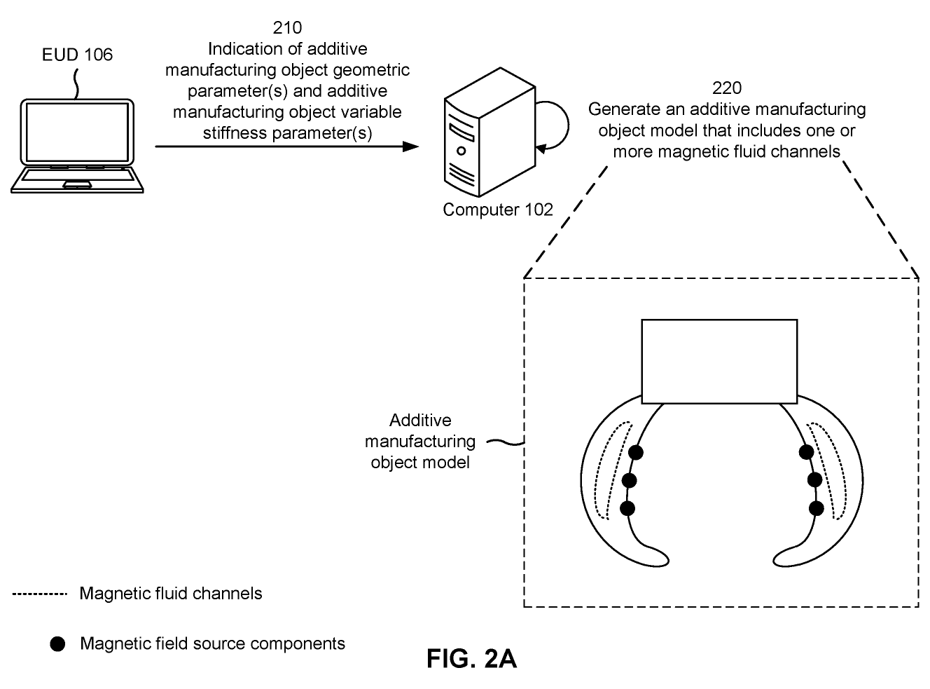

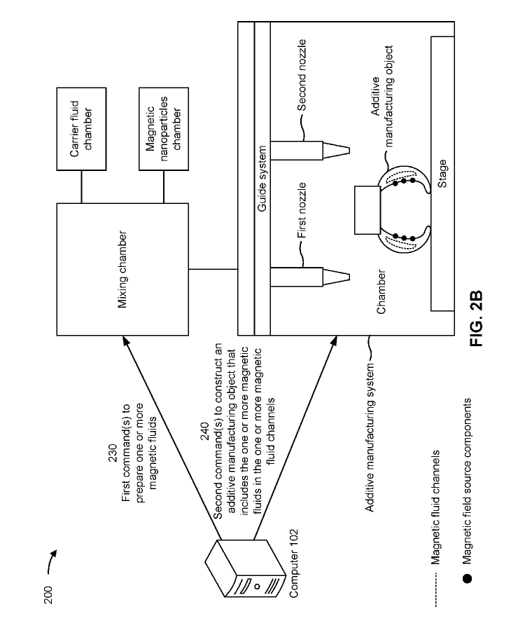

FIGS. 2A-2B are diagrams of an example 200 associated with additive manufacturing with magnetic fluids as described herein.

With reference to FIG. 2A, as shown by reference number 210, the EUD 106 may transmit, and the computer 102 may receive, an indication of one or more additive manufacturing object geometric parameters and one or more additive manufacturing object variable stiffness parameters. The one or more additive manufacturing object geometric parameters may indicate physical attributes of an additive manufacturing object, such as a shape, a size, a structure, or the like. For example, the one or more additive manufacturing object geometric parameters may include one or more dimensions (e.g., length, width, or height), one or more shapes (e.g., circular, rectangular, triangular, or the like), one or more curvatures, one or more angles, or the like. In some examples, the computer 102 may receive an additive manufacturing object model that indicates the one or more additive manufacturing object geometric parameters. The one or more additive manufacturing object variable stiffness parameters may indicate a target variable stiffness of the additive manufacturing object. The stiffness may be “variable” in that a stiffness of a given component of the additive manufacturing object may controllably vary over time. The additive manufacturing object variable stiffness parameter(s) may include a stiffness profile of one or more target locations of the additive manufacturing object, a target magnetic field strength, a target magnetic fluid viscosity, or the like. In some examples, the computer 102 may receive an explicit indication of the one or more additive manufacturing object variable stiffness parameters (e.g., the computer 102 may receive two numbers that define a range of stiffnesses for the given component of the additive manufacturing object). Additionally, or alternatively, the computer 102 may receive an implicit indication of the one or more additive manufacturing object variable stiffness parameters (e.g., the computer 102 may receive information, such as a target use of the additive manufacturing object, a target environment of the additive manufacturing object, or a target material of the additive manufacturing object, and derive the one or more additive manufacturing object variable stiffness parameters therefrom. In some examples, the one or more additive manufacturing object variable stiffness parameters may be indicated with the additive manufacturing object model provided to the computer 102. In example 200, the computer 102 receives the indication of the one or more additive manufacturing object geometric parameters and the one or more additive manufacturing object variable stiffness parameters from the EUD 106; in other examples, the computer 102 may receive the additive manufacturing object geometric parameter(s) and additive manufacturing object variable stiffness parameter(s) from a device or component that is different from the EUD 106, such as the remote server 108, the public cloud 110, the private cloud 112, the UI device set 132, or the like.

As shown by reference number 220, the computer 102 may generate, based on the one or more additive manufacturing object geometric parameters and the one or more additive manufacturing object variable stiffness parameters, an additive manufacturing object model. The additive manufacturing object model may be a digital representation of the additive manufacturing object. For example, the additive manufacturing object may have a shape, size, or structure in accordance with the one or more additive manufacturing object geometric parameters. The additive manufacturing object model may be a digital representation of any suitable additive manufacturing object (e.g., example 200 shows a model of a robotic gripper). The additive manufacturing object model may include a digital representation of one or more magnetic fluid channels. The one or more magnetic fluid channels may be passages internal to the additive manufacturing object configured to hold magnetic fluid. In some examples, the one or more magnetic fluid channels may be designed in accordance with the additive manufacturing object geometric parameters and the one or more additive manufacturing object variable stiffness parameters. For example, the computer 102 may identify which portions of the additive manufacturing object model correspond to given stiffness ranges (e.g., based on the target use of the additive manufacturing object), and assign to those portions the one or more magnetic fluid channels. The one or more magnetic fluid channels may be any suitable shape(s) or dimensions(s). In some examples, the portions (or regions including the portions) may be user-selected. Additionally, or alternatively, the computer 102 may identify the portions autonomously. The digital representation of the one or more magnetic fluid channels may provide the additive manufacturing object model with one or more regions that have variable stiffness. In some examples, the computer 102 may generate the additive manufacturing object model by analyzing the additive manufacturing object model received by the computer 102 and modifying that additive manufacturing object model to include the one or more magnetic fluid channels.

In some aspects, the additive manufacturing object model may include a digital representation of one or more magnetic field source components. In some examples, the one or more magnetic field source components may be devices or elements configured to generate a magnetic field. For example, devices or elements configured to generate a magnetic field may include electromagnets, permanent magnets, electrical conductors, or the like. In some examples, the one or more magnetic field source components may be design features of the additive manufacturing object model that accommodate such devices or elements configured to generate a magnetic field. For example, a design feature may be a recess or protrusion that is shaped to secure or fit a device or element configured to generate a magnetic field. In some examples, the additive manufacturing object model may include a digital representation of one or more components of a magnetic field control system that enables programmatic control over a magnetic field generated by the devices or elements configured to generate a magnetic field. For example, the one or more components of the magnetic field control system may include the one or more magnetic field source components, one or more power supplies, one or more signal controllers, or circuitry that enables regulation of magnetic field strength and distribution locally to the one or more magnetic fluid channels.

In some aspects, the one or more magnetic field source components may be associated with one or more electromagnetic coils. The one or more magnetic field source components may be associated with one or more electromagnetic coils in that the one or more magnetic field source components may be the one or more electromagnetic coils or design features of the additive manufacturing object model that accommodate the one or more electromagnetic coils. An electromagnetic coil (e.g., a magnetic coil circuit) may be an electrical conductor (e.g., a wire) arranged in a coil shape, such that when an electrical current flows through the electrical conductor, a magnetic field is generated around the coil. For example, the additive manufacturing object model may include a digital representation of one or more internal structures that allow the electromagnetic coil(s) to fit therewithin, or that fit within the electromagnetic coil(s). For example, the additive manufacturing object model may include a digital representation of one or more integrated pathways in which the electromagnetic coil(s) may be embedded. In some examples, the computer 102 may identify target positions of the electromagnetic coils that are local to the one or more magnetic fluid channels (e.g., such that the magnetic fluid channels are influenced by the magnetic field generated by the electromagnetic coils). The computer 102 may identify the target positions (e.g., a coil layout) based on a target magnetic field distribution for programmable stiffness. For example, the target positions may be within or on a surface of the additive manufacturing object model (e.g., positions where the electromagnetic coils are to be attached to the additive manufacturing object, positions where the electromagnetic coils are to be printed inside the additive manufacturing object, positions where the electromagnetic coils are to be painted on the additive manufacturing object, positions where electrically conductive wire is to be wound into the electromagnetic coils, or the like). For example, the positions where the electromagnetic coils are to be printed inside the additive manufacturing object may include pre-designed cavities or slots for the electromagnetic coil(s). In some examples, the computer 102 may modify the additive manufacturing object model received by the computer 102 with the electromagnetic coil(s) arranged locally to the one or more magnetic fluid channels. For example, the computer 102 may receive an indication of, or identify, a type, size and/or quantity of the electromagnetic coil(s) for each magnetic channel of the additive manufacturing object model. The type, size and/or quantity of the electromagnetic coil(s) may be based on a target magnetic field strength, a target stiffness modulation or range, or the like.

In some aspects, the computer 102 may generate the additive manufacturing object model based on one or more simulations of the additive manufacturing object in accordance with the one or more additive manufacturing object geometric parameters and the one or more additive manufacturing object variable stiffness parameters. For example, the computer 102 may simulate how one or more components of the additive manufacturing object (or the additive manufacturing object as a whole) respond to applied forces during a target use of the additive manufacturing object. Additionally, or alternatively, the computer 102 may simulate how different configurations of the one or more magnetic fluid channels impact how the one or more components respond under various magnetic fields.

With reference to FIG. 2B, shown is the computer 102, a mixing chamber, a carrier fluid chamber, a magnetic nanoparticles chamber, and an additive manufacturing system. The mixing chamber may be configured (e.g., programmatically controlled) to prepare and/or store a magnetic fluid, the carrier fluid chamber may be configured to store and/or dispense carrier fluid (e.g., silicone oils, water-based fluids, or the like), and the magnetic nanoparticles chamber may be configured to store and/or dispense magnetic nanoparticles (e.g., iron oxide or the like). For example, the mixing chamber may be configured to obtain carrier fluid from the carrier fluid chamber and magnetic nanoparticles from the magnetic nanoparticle chamber, and to mix the carrier fluid and magnetic nanoparticles to produce the magnetic fluid.

In some examples, the additive manufacturing system may be configured to 3D print objects using one or more 3D printing techniques, such as material extrusion. The objects that can be 3D printed by the additive manufacturing system are not limited to any particular type of object, and may include industrial components, consumer components, and/or other types of components. The additive manufacturing system may include a chamber and a stage within the chamber. The chamber may include an internal volume in which additive manufacturing of an object occurs. The stage may include a horizontal plane (e.g., a base plate, a chamber floor, or the like) that is configured to support and provide a surface on which an object is 3D printed. In some examples, a first nozzle and a second nozzle may be located within the chamber above the stage and coupled to a guide system that enables the first nozzle and the second nozzle to be moved and selectively positioned. The guide system may include a combination of belts, gears, motors, structures, and/or other components that enable the first nozzle and the second nozzle to be moved according to a programmed path. In some examples, the guide system may include a gantry to which the first nozzle and the second nozzle are mounted.

The computer 102 may be communicatively coupled to the additive manufacturing system and/or the mixing chamber. For example, the computer 102 may communicate with the additive manufacturing system and/or the mixing chamber over wired and/or wireless communication links using the communication fabric 116, the network module 124, or the like. The computer 102 may control various aspects of the operation of the additive manufacturing system, such as additive manufacturing of an object with magnetic fluid, and/or the mixing chamber, such as preparation of the magnetic fluid. In some examples, the computer 102 may be a part of the additive manufacturing system and/or the mixing chamber, and may correspond to the control system of the additive manufacturing system and/or the mixing chamber (e.g., the computer 102 may be embedded in the form factor of the additive manufacturing system and/or the mixing chamber). In some examples, the computer 102 may be located remotely from the additive manufacturing system and/or the mixing chamber.

As shown by reference number 230, the computer 102 may transmit, and the mixing chamber may receive, based on the one or more additive manufacturing object geometric parameters and the one or more additive manufacturing object variable stiffness parameters, one or more first commands to prepare one or more magnetic fluids. In some examples, the one or more first commands may prompt the mixing chamber to receive the carrier fluid from the carrier fluid chamber and the magnetic nanoparticles from the magnetic nanoparticles chamber. In some examples, the one or more first commands may prompt the mixing chamber to prepare a target volume of the one or more magnetic fluids. The computer 102 may identify the target volume based on a volume of the one or more magnetic fluid channels.

In some aspects, the one or more first commands may be based on one or more of one or more target compositions of the one or more magnetic fluids or one or more target viscosities of the one or more magnetic fluids. The one or more compositions and/or one or more viscosities may determine (at least in part) the degree of stiffness of the magnetic fluid in a given magnetic field strength. A target composition may be a target ratio of the carrier fluid to the magnetic nanoparticles in the magnetic fluid(s), a target ratio between different carrier fluids, and/or a target ratio between different types of magnetic nanoparticles. In some examples, the mixing chamber may be connected to a plurality of magnetic nanoparticle chambers (or a single magnetic nanoparticle chamber with sub-chambers), each housing a different type and/or concentration of magnetic nanoparticles, and the one or more first commands may select one or more of the magnetic nanoparticle chambers (or sub-chambers) to provide magnetic nanoparticles to the mixing chamber at a target ratio. A target viscosity may be a target flow resistance of a magnetic fluid. In some examples, the mixing chamber may be connected to a plurality of carrier fluid chambers (or a single carrier fluid chamber with sub-chambers) storing different carrier fluids with respective viscosities, and the one or more first commands may select one or more of the magnetic nanoparticle chambers (or sub-chambers) to provide carrier fluids to the mixing chamber. Thus, the concentration of magnetic nanoparticles in the magnetic fluid may be modulated to respond to different magnetic field strengths. The computer 102 may identify the target composition(s) and/or the one or more viscosities based on a target stiffness range mapped to one or more sections of the additive manufacturing object under a controlled magnetic field generation. For example, the computer 102 may compare the target stiffness range to a predicted stiffness range that would be achieved with the one or more magnetic fluids, and, if one or more values in the target stiffness range and one or more values in the predicted stiffness range are within a threshold, then the computer 102 may select the one or more magnetic fluids. The computer 102 may identify the predicted stiffness range based on historical data and/or one or more properties of the one or more magnetic fluids (e.g., a composition, a viscosity, or the like). In some examples, the computer 102 may, based on a target stiffness range for one or more sections of the additive manufacturing model, cause the mixing chamber to prepare the one or more magnetic fluids with a given composition and/or viscosity from among a range of possible compositions and/or viscosities. For example, the computer 102 may use the one or more first commands to adjust or set the one or more target compositions or the one or more target viscosities. In some examples, the mixing chamber may, based on the first command(s), mix the carrier fluid(s) and magnetic nanoparticles using a rotating shaft, a turbine, or other component. In some examples, the ratio of carrier fluid to magnetic nanoparticles that enter the mixing chamber may be dynamically controlled or maintained using motors and/or valves. For example, the composition and/or viscosity of the magnetic fluid may remain constant or vary over time and in magnetic responsiveness. In some examples, the ratio of carrier fluids with different viscosities may be adjusted based on target flow characteristics and target stiffness properties under an applied magnetic field.

As shown by reference number 240, the computer 102 may transmit, and the additive manufacturing system may receive, one or more second commands to construct an additive manufacturing object that includes the one or more magnetic fluids in the one or more magnetic fluid channels. In some examples, the one or more second commands may prompt the additive manufacturing system to construct the additive manufacturing object using an additive manufacturing material (e.g., filament) and the magnetic fluid(s) prepared in the mixing chamber. For example, the one or more second commands may prompt the additive manufacturing system to perform an additive manufacturing process, such as a 3D printing process. For example, the computer 102 may synchronize a 3D printing module (e.g., software responsible for dispensing of the additive manufacturing material) with a magnetic fluid filling module (e.g., software responsible for dispensing of the magnetic fluid(s)) during the additive manufacturing process. For example, the computer 102 may cause the additive manufacturing system to print the additive manufacturing object (including the magnetic fluid channel(s)) using the additive manufacturing material, and fill the magnetic fluid channel(s) with the magnetic fluid(s) using a programmatically controlled pump (e.g., the programmatically controlled pump may inject the magnetic fluid(s) into the magnetic fluid channel(s)). In some examples, during the additive manufacturing process, the computer 102 may, using the first command(s), dynamically adjust the magnetic fluid mixture in real-time for each section of the additive manufacturing object. For example, the computer 102 may fine-tune the concentration of magnetic nanoparticles (which may influence magnetic responsiveness, and, thus, a target stiffness under an applied magnetic field) and modify the viscosity of the carrier fluid (which may also impact the target stiffness under the applied magnetic field). In some examples, the one or more second commands may cause the additive manufacturing system to print the magnetic field source component(s) associated with the electromagnetic coil(s). For example, the electromagnetic coil(s) may be integrated into the additive manufacturing object locally to the magnetic fluid channel(s). In some examples, pre-designed cavities or slots may be filled with the electromagnetic coil(s) during the additive manufacturing process (e.g., by embedding the electromagnetic coil(s) directly within the layers of the additive manufacturing object). In some examples, the pre-designed cavities or slots may be filled with the electromagnetic coil(s) after the additive manufacturing process has concluded (e.g., after the additive manufacturing system has constructed the additive manufacturing object).

In some aspects, the one or more second commands may be to construct the additive manufacturing object using one or more first nozzles associated with the one or more magnetic fluids and one or more second nozzles associated with one or more additive manufacturing materials that are different from the one or more magnetic fluids. The first nozzle(s) may be associated with the one or more magnetic fluids in that the first nozzle(s) may be configured to provide the one or more magnetic fluids (e.g., to inject the magnetic fluid into a magnetic fluid channel). For example, the first nozzle(s) may include a material jet, a material extrusion nozzle, and/or another type of head through which the magnetic fluid is injected into the magnetic channel(s). The first nozzle(s) may be dedicated for the magnetic fluid. In some examples, the first nozzle(s) may be referred to as “magnetic fluid filling nozzle(s).” The second nozzle(s) may be associated with the one or more additive manufacturing material(s) in that the second nozzle(s) may be configured to provide (e.g., lay down) the additive manufacturing material(s). For example, the second nozzle(s) may include a material jet, a material extrusion nozzle, and/or another type of head through which the additive manufacturing material(s) is/are deposited onto the stage and/or the additive manufacturing object in layers. The additive manufacturing material may be filament material or any other suitable 3D printing material, such as a material that hardens after being extruded from the second nozzle(s). The second nozzle(s) may be dedicated for 3D printing (e.g., for forming a structure of the additive manufacturing object). In some examples, the second nozzle(s) may be referred to as “3D printing nozzle(s).” In some examples, a 3D printing and magnetic fluid filling synchronization module (e.g., a software module) may enable the computer 102 to control coordination between the first nozzle and the second nozzle and/or movement of the first nozzle and the second nozzle along the gantry. The 3D printing and magnetic fluid filling synchronization module may manage the 3D printing module and the magnetic fluid filling module, and coordinate timing and sequencing of the 3D printing process (e.g., a process of printing in which the first nozzle(s) are engaged) and a magnetic fluid filling process (e.g., a process of filling in which the second nozzle(s) are engaged). In some examples, the computer 102 may segment the additive manufacturing object into different regions corresponding to the magnetic fluid channel(s), and estimate the volume of magnetic fluid that will fill the magnetic fluid channel(s). This estimation may help the computer 102 to identify when and where the magnetic fluid is to be dispensed (e.g., when a magnetic fluid channel is ready to be filled with magnet fluid). The computer 102 may, via the second command(s), cause the additive manufacturing system to fill the magnetic channel with the magnetic fluid (e.g., using the first nozzle(s)) and seal the magnetic fluid channel (e.g., using the second nozzle(s)). Thus, the computer 102 may dynamically coordinate the nozzle(s) using the programmatically controlled pump to regulate the composition and injection of magnetic fluid(s) into the magnetic fluid channel(s).

In some aspects, the additive manufacturing object model may include multiple magnetic fluid channels that include respective magnetic fluids. For example, the computer 102 may identify and cause the additive manufacturing system to create multiple magnetic fluid channels that contain various magnetic fluids having varying magnetic and stiffness properties. For example, the first nozzle(s) may inject the respective magnetic fluids into the multiple magnetic fluid channels. As a result, the multiple magnetic fluid channels may respond differently in terms of stiffness to a given magnetic field strength.

In some aspects, the one or more first commands or the one or more second commands may be based on one or more idle times of the one or more first nozzles or the one or more second nozzles. An idle time of a nozzle may be a time during which the nozzle is in a passive state (e.g., not printing or filling). For example, an idle time may be a time during which no magnetic fluid or additive manufacturing material is exiting a nozzle. For example, the computer 102 may synchronize and execute the 3D printing process and the magnetic fluid filling process such that the idle time(s) of the nozzles are minimized. For example, the computer 102 may dynamically plan an appropriate time for creating a magnetic fluid (controlled via the first command(s)), and/or for switching between printing and filling (controlled via the second command(s)), such that an aggregate idle time of the first and second nozzles is minimized. The computer 102 may create the plan based on one or more properties of a magnetic fluid channel (e.g., volume, size, dimensions, location, or the like), a composition of the magnetic fluid that is to fill the magnetic fluid channel, historical data, simulation data, a print speed, a layer curing time, or the like. For example, the computer 102 may identify lengths of time that are required to prepare magnetic fluids having respective first compositions, lengths of time that are required to fill magnetic fluid channels with the magnet fluids, lengths of time that are required to print the passage, volumes of the magnet fluid channels, or the like. The computer 102 may, using the first command(s), indicate when the mixing chamber is to mix the magnetic fluids such that the magnetic fluids are prepared in time for the first nozzle(s) to dispense the magnetic fluid(s) with reduced or minimal idle time. In some examples, the additive manufacturing system may include one or more sensors or cameras that collect and transmit monitoring data regarding the 3D printing process and the magnetic fluid filling process. The computer 102 may receive the monitoring data, and, based on the monitoring data, identify when the mixing chamber is to start mixing a magnetic fluid, and when the additive manufacturing system is to start filling a magnetic fluid chamber with the magnetic fluid.

FIGS. 2A-2B are provided as an example. Other examples may differ from what is described with regard to FIGS. 2A-2B.

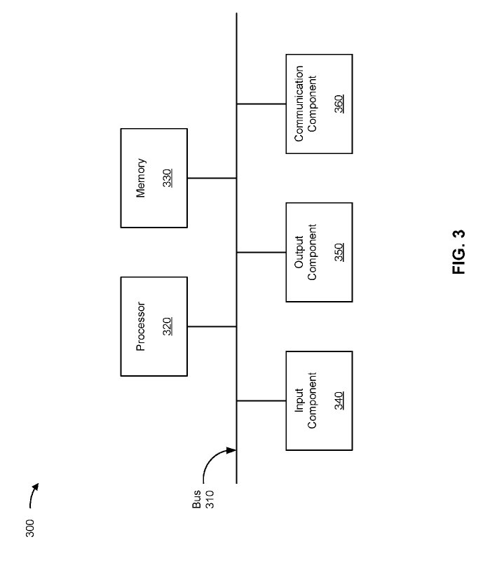

FIG. 3 is a diagram of example components of a device 300 associated with additive manufacturing with magnetic fluids. The device 300 corresponds to one or more of the computer 102, EUD 106, the remote server 108, the public cloud 110, and/or the private cloud 112. In some implementations, the computer 102, EUD 106, the remote server 108, the public cloud 110, and/or the private cloud 112 include one or more devices 300 and/or one or more components of the device 300. In the example shown in FIG. 3, the device 300 includes a bus 310, a processor 320, a memory 330, an input component 340, an output component 350, and/or a communication component 360.

The bus 310 includes one or more components that enable wired and/or wireless communication among the components of the device 300. The bus 310 couples together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 includes a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory, such as RAM, read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). In some implementations, the memory 330 is a non-transitory computer-readable medium. The memory 330 stores information, one or more instructions, and/or software (e.g., one or more software applications) related to the operation of the device 300. In some implementations, the memory 330 includes one or more memories that are coupled (e.g., communicatively coupled) to one or more processors (e.g., processor 320), such as via the bus 310. Communicative coupling between a processor 320 and a memory 330 enables the processor 320 to read and/or process information stored in the memory 330 and/or to store information in the memory 330.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

In some implementations, the device 300 performs one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry is used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

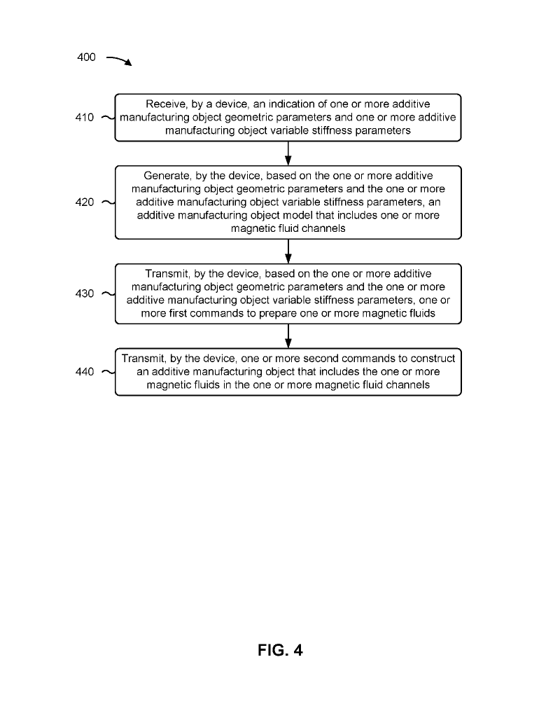

FIG. 4 is a flowchart of an example process 400 associated with additive manufacturing with magnetic fluids. One or more process blocks of FIG. 4 are performed by a device (e.g., computer 102) and/or by another device or a group of devices separate from or including the device, such as a EUD (e.g., EUD 106), a remote server (e.g., remote server 108), a public cloud (e.g., public cloud 110) and/or a private cloud (e.g., private cloud 112). Additionally, or alternatively, one or more process blocks of FIG. 4 may be performed by one or more components of device 300, such as processor 320, memory 330, input component 340, output component 350, and/or communication component 360.

As shown in FIG. 4, process 400 includes receiving an indication of one or more additive manufacturing object geometric parameters and one or more additive manufacturing object variable stiffness parameters (block 410). For example, the device may receive an indication of one or more additive manufacturing object geometric parameters and one or more additive manufacturing object variable stiffness parameters, as described above.

As further shown in FIG. 4, process 400 includes generating, based on the one or more additive manufacturing object geometric parameters and the one or more additive manufacturing object variable stiffness parameters, an additive manufacturing object model that includes a digital representation of one or more magnetic fluid channels (block 420). For example, the device may generate, based on the one or more additive manufacturing object geometric parameters and the one or more additive manufacturing object variable stiffness parameters, an additive manufacturing object model that includes a digital representation of one or more magnetic fluid channels, as described above.

As further shown in FIG. 4, process 400 includes transmitting, based on the one or more additive manufacturing object geometric parameters and the one or more additive manufacturing object variable stiffness parameters, one or more first commands to prepare one or more magnetic fluids (block 430). For example, the device may transmit, based on the one or more additive manufacturing object geometric parameters and the one or more additive manufacturing object variable stiffness parameters, one or more first commands to prepare one or more magnetic fluids, as described above.

As further shown in FIG. 4, process 400 includes transmitting one or more second commands to construct an additive manufacturing object that includes the one or more magnetic fluids in the one or more magnetic fluid channels (block 440). For example, the device may transmit one or more second commands to construct an additive manufacturing object that includes the one or more magnetic fluids in the one or more magnetic fluid channels, as described above.

Process 400 may include additional aspects, such as any single aspect or any combination of aspects described below and/or in connection with one or more other processes described elsewhere herein.

In a first aspect, the one or more second commands are to construct the additive manufacturing object using one or more first nozzles associated with the one or more magnetic fluids and one or more second nozzles associated with one or more additive manufacturing materials that are different from the one or more magnetic fluids.

In a second aspect, alone or in combination with the first aspect, the one or more first commands or the one or more second commands are based on one or more idle times of the one or more first nozzles or the one or more second nozzles.

In a third aspect, alone or in combination with one or more of the first and second aspects, the additive manufacturing object model includes a digital representation of one or more magnetic field source components.

In a fourth aspect, alone or in combination with one or more of the first through third aspects, the one or more magnetic field source components are associated with one or more electromagnetic coils.

In a fifth aspect, alone or in combination with one or more of the first through fourth aspects, the one or more magnetic fluids include multiple magnetic fluids, and the one or more magnetic fluid channels include multiple magnetic fluid channels that include respective magnetic fluids of the multiple magnetic fluids.

In a sixth aspect, alone or in combination with one or more of the first through fifth aspects, generating the additive manufacturing object model comprises generating the additive manufacturing object model based on one or more simulations of the additive manufacturing object in accordance with the one or more additive manufacturing object geometric parameters and the one or more additive manufacturing object variable stiffness parameters.

In a seventh aspect, alone or in combination with one or more of the first through sixth aspects, the one or more first commands are based on one or more of one or more target compositions of the one or more magnetic fluids or one or more target viscosities of the one or more magnetic fluids.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method comprising:
receiving, by a device, an indication of one or more additive manufacturing object geometric parameters and one or more additive manufacturing object variable stiffness parameters;
generating, by the device, based on the one or more additive manufacturing object geometric parameters and the one or more additive manufacturing object variable stiffness parameters, an additive manufacturing object model that includes a digital representation of one or more magnetic fluid channels;
transmitting, by the device, based on the one or more additive manufacturing object geometric parameters and the one or more additive manufacturing object variable stiffness parameters, one or more first commands to prepare one or more magnetic fluids; and
transmitting, by the device, one or more second commands to construct an additive manufacturing object that includes the one or more magnetic fluids in the one or more magnetic fluid channels.

2. The computer-implemented method of claim 1, wherein the one or more second commands are to construct the additive manufacturing object using one or more first nozzles associated with the one or more magnetic fluids and one or more second nozzles associated with one or more additive manufacturing materials that are different from the one or more magnetic fluids.

3. The computer-implemented method of claim 2, wherein the one or more first commands or the one or more second commands are based on one or more idle times of the one or more first nozzles or the one or more second nozzles.

4. The computer-implemented method of claim 1, wherein the additive manufacturing object model includes a digital representation of one or more magnetic field source components.

5. The computer-implemented method of claim 4, wherein the one or more magnetic field source components are associated with one or more electromagnetic coils.

6. The computer-implemented method of claim 1, wherein the one or more magnetic fluids include multiple magnetic fluids, and the one or more magnetic fluid channels include multiple magnetic fluid channels that include respective magnetic fluids of the multiple magnetic fluids.

7. The computer-implemented method of claim 1, wherein generating the additive manufacturing object model comprises:
generating the additive manufacturing object model based on one or more simulations of the additive manufacturing object in accordance with the one or more additive manufacturing object geometric parameters and the one or more additive manufacturing object variable stiffness parameters.

8. The computer-implemented method of claim 1, wherein the one or more first commands are based on one or more of one or more target compositions of the one or more magnetic fluids or one or more target viscosities of the one or more magnetic fluids.

9. A computer system comprising:
a processor set;
one or more computer-readable storage media; and
program instructions stored on the one or more computer-readable storage media to cause the processor set to perform operations comprising:
receiving an indication of one or more additive manufacturing object geometric parameters and one or more additive manufacturing object variable stiffness parameters;
generating, based on the one or more additive manufacturing object geometric parameters and the one or more additive manufacturing object variable stiffness parameters, an additive manufacturing object model that includes a digital representation of one or more magnetic fluid channels;
transmitting, based on the one or more additive manufacturing object geometric parameters and the one or more additive manufacturing object variable stiffness parameters, one or more first commands to prepare one or more magnetic fluids; and
transmitting one or more second commands to construct an additive manufacturing object that includes the one or more magnetic fluids in the one or more magnetic fluid channels using one or more first nozzles associated with the one or more magnetic fluids and one or more second nozzles associated with one or more additive manufacturing materials that are different from the one or more magnetic fluids.

10. The computer system of claim 9, wherein the one or more first commands or the one or more second commands are based on one or more idle times of the one or more first nozzles or the one or more second nozzles.

11. The computer system of claim 9, wherein the additive manufacturing object model includes a digital representation of one or more magnetic field source components.

12. The computer system of claim 9, wherein the one or more magnetic fluids include multiple magnetic fluids, and the one or more magnetic fluid channels include multiple magnetic fluid channels that include respective magnetic fluids of the multiple magnetic fluids.

13. The computer system of claim 9, wherein generating the additive manufacturing object model comprises:
generating the additive manufacturing object model based on one or more simulations of the additive manufacturing object in accordance with the one or more additive manufacturing object geometric parameters and the one or more additive manufacturing object variable stiffness parameters.

14. The computer system of claim 9, wherein the one or more first commands are based on one or more of one or more target compositions of the one or more magnetic fluids or one or more target viscosities of the one or more magnetic fluids.

15. A computer program product comprising:
one or more computer-readable storage media; and
program instructions stored on the one or more computer-readable storage media to perform operations comprising:
receiving an indication of one or more additive manufacturing object geometric parameters and one or more additive manufacturing object variable stiffness parameters;
generating, based on the one or more additive manufacturing object geometric parameters and the one or more additive manufacturing object variable stiffness parameters, an additive manufacturing object model that includes a digital representation of one or more magnetic fluid channels and one or more magnetic field source components associated with one or more electromagnetic coils;
transmitting, based on the one or more additive manufacturing object geometric parameters and the one or more additive manufacturing object variable stiffness parameters, one or more first commands to prepare one or more magnetic fluids; and
transmitting one or more second commands to construct an additive manufacturing object that includes the one or more magnetic fluids in the one or more magnetic fluid channels.

16. The computer program product of claim 15, wherein the one or more second commands are to construct the additive manufacturing object using one or more first nozzles associated with the one or more magnetic fluids and one or more second nozzles associated with one or more additive manufacturing materials that are different from the one or more magnetic fluids.

17. The computer program product of claim 16, wherein the one or more first commands or the one or more second commands are based on one or more idle times of the one or more first nozzles or the one or more second nozzles.

18. The computer program product of claim 15, wherein the one or more magnetic fluids include multiple magnetic fluids, and the one or more magnetic fluid channels include multiple magnetic fluid channels that include respective magnetic fluids of the multiple magnetic fluids.

19. The computer program product of claim 15, wherein generating the additive manufacturing object model comprises:
generating the additive manufacturing object model based on one or more simulations of the additive manufacturing object in accordance with the one or more additive manufacturing object geometric parameters and the one or more additive manufacturing object variable stiffness parameters.

20. The computer program product of claim 15, wherein the one or more first commands are based on one or more of one or more target compositions of the one or more magnetic fluids or one or more target viscosities of the one or more magnetic fluids.
